(19) United States
(12) Patent Application Publication
(10) Pub. No.: US 2013/0022806 A1
(43) Pub. Date: Jan. 24, 2013

(54) MULTILAYER FLUORINATED FILMS

(71) Applicants: Anthony Bonnet, Saint Laurent de Mure (FR); Nicolas Devaux, Lyon (FR); Stephane Bizet, Barc (FR); Nadine Rivas, La Londe (FR); Frederic Godefroy, Mesnil Sous Jumieges (FR)

(72) Inventors: Anthony Bonnet, Saint Laurent de Mure (FR); Nicolas Devaux, Lyon (FR); Stephane Bizet, Barc (FR); Nadine Rivas, La Londe (FR); Frederic Godefroy, Mesnil Sous Jumieges (FR)

(73) Assignee: Arkema France, Colombes (FR)

(21) Appl. No.: 13/637,398

(22) PCT Filed: Mar. 29, 2011
(86) PCT No.: PCT/FR2011/050688

§ 371 Date: Sep. 26, 2012

(30) Foreign Application Priority Data
Mar. 30, 2010 (FR) 1052325

(51) Int. Cl. B32B 27/08; A01G 13/02; A01G 9/14; B29C 49/22

(52) U.S. Cl. 428/220; 428/421; 264/512; 47/20.1; 47/17

(57) ABSTRACT

The present invention relates to multilayer films made of fluoro polymers, which have properties that make them suitable for use in the agricultural field, especially as greenhouse covering films. According to a first aspect, the invention relates to multilayer fluorinated films comprising at least three layers, including a layer A made of a first vinylidene fluoride copolymer with a crystallization temperature TcA, and a layer B made of a second vinylidene fluoride copolymer with a crystallization temperature TcB, TcA being greater than TcB, layers A and B being alternating, layer A being placed to the exterior and layer B between two layers A. Another subject of the invention relates to the use of the film according to the invention as an agricultural covering material, especially as a greenhouse covering.

The present invention relates to multilayer films made of fluoro polymers which have properties that make them suitable for use in the agricultural field, especially as greenhouse covering films (or greenhouse films).

In general, greenhouse films must have many properties: mechanical, such as: tear strength, creep resistance, drawability; optical, such as light transmission, resistance to UV rays; chemical resistance; durability; thermal resistance (high capacity to reflect infrared rays in the greenhouse overnight, keeping the thermal energy inside). Moreover, to cover large-sized modern greenhouses, it is essential to have films of substantial width, for example from 1 m to 7 m wide.

Among the films used as greenhouse coverings are high-density polyethylene (HDPE) films, These films are manufactured by tubular film blowing, which makes it possible to obtain films of substantial width (ranging up to 11 m in circumference). The main drawback of HDPE greenhouse films lies in their UV stability that is limited over time (about 4 years), which imposes frequent changing of these films.

Films made of ethylene-tetrafluoroethylene copolymer (ETFE) overcome this drawback, since they have a duration of use as greenhouse films of up to 20 years. Furthermore, they have other advantages such as good creep resistance at low temperature and self-cleanability. On the other hand, the width of these films, manufactured via the cast film technique, does not exceed about 2.3 m. To obtain a film suitable for covering an entire greenhouse, it is thus necessary to weld several sheets of film together over their width, which increases the manufacturing costs. Another drawback of ETFE films is their very limited drawability, which makes them difficult to lay on the metal framework of greenhouses.

Low-density polyethylene (LDPE) films are also known, which are used as agricultural material, alone or as covering materials on a more solid support such as polypropylene or alternatively in multilayer structures coextruded with ethylene-vinyl acetate (EVA) copolymers. None of these films satisfies all the requirements listed above. Their ultraviolet stability is poor and does not allow external use for longer than 5 years.

It is also known practice to use fluoro polymers, especially based on vinylidene fluoride, to manufacture monolayer films for agricultural uses. Monolayer films of PVDF (polyvinylidene fluoride) or VF2/HFP (vinylidene fluoride/hexafluoropropylene) copolymers, obtained by tubular film blowing or via the east film technique, have good mechanical, optical, chemical resistance and durability properties, and as such they are good candidates for agricultural greenhouse use. The tear strength of these films is, however, insufficient, especially in the extrusion direction (MD). No modification made to the product or to the transformation process has made it possible to significantly improve the MD tear strength.

It would thus be desirable to have available plastic films for use as greenhouse coverings, which, in addition to the general characteristics outlined above, have good tear strength properties, especially in the extrusion direction. One of the subjects of the present invention consists of multilayer films made of fluoro polymers, comprising at least three layers, including a layer A made of a first vinylidene fluoride copolymer with a crystallization temperature TcA, and a layer B made of a second vinylidene fluoride copolymer with a crystallization temperature TcB, TcA being greater than TcB, layers A and B being alternating, layer A being placed at the exterior and layer B between two layers A.

Another subject of the invention concerns the use of the film according to the invention as an agricultural covering material, especially as a greenhouse covering.

Other characteristics and advantages of the invention will emerge on reading the description that follows.

It has now been found that by using multilayer structures made of vinylidene fluoride (VDF) copolymers and by carefully selecting the components of these layers, the number of layers and the thicknesses, a significant improvement in the MD tear strength is obtained. Such an improvement is not known to those skilled in the art, even for other products such as polyethylene.

According to a first aspect, the invention relates to multilayer fluorinated films comprising at least three layers, including a layer A made of a first vinylidene fluoride copolymer with a crystallization temperature TcA, and a layer B made of a second vinylidene fluoride copolymer with a crystallization temperature TcB, TcA being greater than TcB, layers A and B being alternating, layer A being placed to the exterior and layer B between two layers A.

The fluorinated copolymers included in the composition of the film according to the invention are prepared by copolymerization of vinylidene fluoride (VDF, Cf₂═CF₂) with a fluorinated comonomer chosen, for example, from: vinyl fluoride; trifluoroethylene (VF3); chlorotrifluoroethylene (CTFE); 1,2-difluoroethylene; tetrafluoroethylene (TFE); hexafluoropropylene (HFP); perfluoro(alkyl vinyl) ethers such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD), and mixtures thereof.

Preferably, the fluorinated comonomer is chosen from chlorotrifluoroethylene (CTFE), hexafluoropropylene (HFP), trifluoroethylene (VF3) and tetrafluoroethylene (TFE), and mixtures thereof.

The comonomer is advantageously HFP since it copolymerizes well with VDF and affords good thermomechanical properties. Preferably, the copolymer comprises only VDF and HFP.

Advantageously, the VDF copolymers have a viscosity ranging from 100 Pa·s to 3000 Pa·s, the viscosity being measured at 230° C., at a shear rate of 100 s⁻¹ using a capillary rheometer. Specifically, this type of polymer is well suited to extrusion. Preferably, the polymers have a viscosity ranging from 500 Pa·s to 2900 Pa·s, the viscosity being measured at 230° C., at a shear rate of 100 s⁻¹ using a capillary rheometer.

Preferably, the fluorinated copolymers are VDF copolymers such as VDF-HFP containing at least 50% by mass of VDF, advantageously at least 75% by mass of VDF and preferably at least 80% by mass of VDF. These fluorinated copolymers specifically have good chemical resistance, especially good UV stability, and they are easily transformed (more easily than PTFE or ETFE copolymers) for the purpose of forming films. Mention may be made, for example, more particularly of VDF copolymers containing more than 75% of VDF and the remainder of the following HEPs: Kynar® 710, Kynar® 720, Kynar® 740, Kynar Flex® 2500, Kynar Flex® 2800, sold by the company Arkema.

The film according to the invention comprises at least three layers, including a layer A made of a first vinylidene fluoride copolymer with a crystallization temperature TcA, and a layer B made of a second vinylidene fluoride copolymer with a crystallization temperature TcB. Layers A and B are both formed from fluorinated copolymers as described above; these fluorinated copolymers differ from each other in the crystallization temperature and/or the elastic modulus. Advantageously, TcA is greater than TcB Layers A and B are alternating in the film according to the invention such that the more rigid layer is to the exterior, to form structures of the type A-B-A or A-B-A-B-A or A-B-A-B-A-B-A. This alternating multilayer structure leads to a significant improvement in the mechanical properties of the film thus obtained, especially its tear strength in the extrusion direction.

If we denote the elastic modulus of layer A as E_{A} and the elastic modulus of layer B as E_{B} (E_{A} and E_{B} being measured in MPa), the film according to the invention is also characterized in that E_{A} is greater than E_{B}. The elastic modulus is measured, for example, according to test ISO 178.

Preferably, the film according to the invention has a mass content of layer B of between 5% and 50%, in one particularly preferred variant, the film comprises between 10% and 35% of layer B.

In one embodiment, in the film according to the invention, layer A is a VF2/HFP copolymer with a melting point of at least 140° C. (for example Kynar Flex® 2800) and layer B is a VF2/HFP copolymer with a melting point of less than 125° C. (for example Kynar Flex® 2500),

The film according to the invention has a thickness of from 50 to 1000 μm; layer A has a thickness of from 5 to 250 μm and layer B has a thickness of from 1 to 50 μm. Preferably, the film has a thickness of from 5 to 200 μm, with a layer A with a thickness of between 20 and 50 μm and a layer B with a thickness of between 5 and 50 μm.

Advantageously, the film according to the invention is free of acrylate.

Unlike other known films based on fluoro polymers, for example those described in document EP 1 090 955 which comprise copolymers of TFE and of another monomer such as ethylene or propylene, the multilayer film according to the invention is composed entirely (to 100% by weight) of fluoro polymers. The film according to the invention is thus free of olefins.

Unlike the three-layer film based on fluoro polymers described in document EP 733 475, which comprises an ABC structure comprising:
a 1st layer of composition A comprising a fluoro polymer;
a 2nd layer of composition B comprising a filled fluoro polymer, and
a 3rd layer of composition C comprising a fluoro polymer C,
   the multilayer film according to the invention is characterized in that each of the layers is formed from a VDF copolymer, whereas the examples of this document disclose only films in which at least one of the layers is formed from PVDF homopolymer.

Advantageously, the film according to the invention has a width of from 1 to 7 m. When the film has a minimum width of 5.5 m, it allows use as a one-piece greenhouse covering film (not welded). Moreover, the film according to the invention has good optical properties, especially having a total transmission of greater than 60%. The total transmission is measured according to standard ASTM D 1003.

The films of the invention may be subjected to a standardized tear test: Elmendorf method—Standard ISO 6383/2—1983(F). According to this test, tear strength measurements are taken in the diagonal directions defined previously (±45 degrees relative to the longitudinal direction). The adopted criterion is the absolute value of the difference between the tear strength in one of the diagonal directions and the tear strength in the other diagonal direction (ΔRD45). The films described here have a tear strength measured in the extrusion direction of greater than 5 g/μm as measured by the Elmendorf method.

According to another aspect, the invention relates to processes for preparing films described above. These films may be obtained by tubular film blowing or by the cast film technique, these techniques advantageously making it possible to obtain films of substantial width, The films may be extruded at a temperature of between 240 and 260° C. The swelling ratio should be between 2.3 and 3. The draw down ratio should be between 2 and 7.

The examples that follow illustrate the invention, In these examples, the following products have been used as VDF copolymers:
Kynar Flex 2500-20 with a crystallization temperature or Tc of 79° C. and an elastic modulus E of 220 MPa;
Kynar Flex 2800-00 with a Tc of 111° C. and an elastic modulus of 650 MPa.

The Tc values were measured by DSC or differential scanning calorimetry. The elastic moduli were measured by the test ISO 178.

### EXAMPLE 1

### According to the Invention ratio 80% 2800, 20% 2500

Kynar Flex 2800-00 (MFR=5 at 230° C. under 12.5 kg) and Kynar SuperFlex 2500-20 (MFR=7 at 230° C. under 3.8 kg) from the company Arkema are introduced into a 7-layer extruder by introducing Kynar Flex 2800 into extruders 1, 2, 6 and 7 and Kynar Super Flex 2500-20 into extruders 3, 4 and 5. This makes it possible to obtain a three-layer film with, as layer No. 1 (extruders 1 and 2), 2800-00 40 μm thick, 2500-20 20 μm thick (extruders 3, 4 and 5) as layer No. 2 and 2800-00 40 μm thick (extruders 6 and 7) for layer No. 3. This film is extruded at a temperature of 250° C., a line speed of 7 m/minute, a draw down ratio (DDR) of 4, and a swelling ratio (BUR) of 2.65. This film is then subjected to a tear strength test in the cross direction and in the long direction according to the Elmendorf method. In the long direction the value obtained is 8 g/μm, and 25 g/μm in the cross direction. A total light transmission measurement is taken on the 100 μm film, and a value of 93% is obtained. The elongation at break value in the two directions is greater than 300% when measured at 23° C. at a throughput speed of 50 mm/minute. This film once again undergoes a tear test after spending 1 week at 40° C. in a ventilated oven. The values in the long direction and in the cross direction maintained 90% of their initial value.

### EXAMPLE 2

### According to the Invention ratio 80% 2800, 20% 2500

Kynar Flex 2800-00 (MFR=5 at 230° C. under 12.5 kg) and Kynar SuperFlex 2500-20 (MFR=7 at 230° C. under 3.8 kg) from the company Arkema are introduced into a 7-layer extruder by introducing Kynar Flex 2800 into extruders 1, 4, and 7 and Kynar Super Flex 2500-20 into extruders 2, 3, 5 and 6. This makes it possible to obtain a 5-layer film with, as layer No. 1 (extruder 1), 2800-00 30 μm thick, 2500-20 10 μm thick (extruders 2 and 3) as layer No. 2, 2800-00 20 μm thick (extruder 4) for layer No. 3, 2500-20 10 μm thick (extruders 5 and 6) as layer No. 4 and 2800-00 (extruder 7) 30 μm thick as layer No. 5. This film is extruded at a temperature of 250° C., a line speed of 7 m/minute, a draw down ratio (DDR) of 4, and a swelling ratio (BUR) of 2.65. This film is then subjected to a tear strength test in the cross direction and in the long direction according to the Elmendorf method. In the long direction the value obtained is 14 g/μm, and 26 g/μm in the cross direction. A total light transmission measurement is taken on the 100 μm film, and a value of 93% is obtained. The elongation at break value in the two directions is greater than 300% when measured at 23° C. at a throughput speed of 50 mm/minute. This film once again undergoes a tear test after spending 1 week at 40° C. in a ventilated oven. The values in the long direction and in the cross direction maintained 90% of their initial value.

### EXAMPLE 3

### According to the Invention Ratio 80% 2800, 20% 2500

Kynar Flex 2800-00 (MFR=5 at 230° C. under 12.5 kg) and Kynar SuperFlex 2500-20 (MFR=7 at 230° C. under 3.8 kg) from the company Arkema are introduced into a 7-layer extruder by introducing Kynar Flex 2800 into extruders 1, 3, 5 and 7 and Kynar Super Flex 2500-20 into extruders 2, 4 and 6. This makes it possible to obtain a 7-layer film with, as layer No. 1 (extruder 1), 2800-00 30 μm thick, 2500-20 5 μm thick (extruder 2) as layer No. 2 and 2800-00 10 μm thick (extruder 3) for layer No. 3, 2500-20 10 μm thick (extruder 4) as layer No. 4, 2800-00 10 μm thick (extruder 5) as layer No. 5, 2500-20 5 μm thick (extruder 6) as layer No. 6 and 2800-00 30 μm thick (extruder 7) as layer No. 7. This film is extruded at a temperature of 250° C. a line speed of 7 m/minute, a draw down ratio (DDR) of 4, and a swelling ratio (BUR) of 2.65. This film is then subjected to a tear strength test in the cross direction and in the long direction according to the Elmendorf method. In the long direction the value obtained is 20 g/μm, and 28 g/μm in the cross direction. A total light transmission measurement is taken on the 100 μm film, and a value of 93% is obtained. The elongation at break value in the two directions is greater than 300% when measured at 23° C. at a throughput speed of 50 mm/minute. This film once again undergoes a tear test after spending 1 week at 40° C. in a ventilated oven. The values in the long direction and in the cross direction maintained 90% of their initial value.

### EXAMPLE 4

### Comparative 100% of 2800

Kynar Flex 2800-00 (MFR=5 at 2.30° C. under 12.5 kg) from the company Arkema is introduced into a 7-layer extruder, by introducing into extruders 1, 2, 3, 4, 5, 6 and 7 Kynar Flex 2800-00. This makes it possible to obtain a monolayer film 100 μm thick. This film is extruded at a temperature of 250° C., a line speed of 7 m/minute, a draw down ratio (DDR) of 4 and a swelling ratio (BUR) of 2.65. This film then undergoes a test of tear strength in the cross direction and in the long direction according to the Elmendorf method. In the long direction, the value obtained is 2 g/μm, and 30 g/μm in the cross direction. A total light transmission measurement is taken on the 100 μm film, and a value of 93% is obtained. The elongation at break value in the two directions is greater than 300% when measured at 23° C. at a throughput speed of 50 mm/minute, This film undergoes a new tear test after spending 1 week at 40° C. in a ventilated oven. The values in the long direction and in the cross direction. maintained 90% of their initial value.

### EXAMPLE 5

### Comparative 95% 2800+5% PMMA V046 Mixture

A mixture of PMMA VO46 at 5% by mass and of Kynar Flex 2800-00 (MFR=5 at 230° C. under 12.5 kg) at 95% by mass, the PMMA and the PVDF coming from the company Arkema, is introduced into a 7-layer extruder, by introducing this mixture into extruders 1, 2, 3, 4, 5, 6 and 7. This makes it possible to obtain a monolayer film 100 μm thick. This film is extruded at a temperature of 250° C., a line speed of 7 in/minute, a draw down ratio (DDR) of 4 and a swelling ratio (BUR) of 2.65, This film then undergoes a test of tear strength in the cross direction and in the long direction according to the Elmendorf method. In the long direction the value obtained is 10 g/μm, and 25 g/μm in the cross direction. A total light transmission measurement is taken on the 100 μm film, and a value of 93% is obtained. The elongation at break value in the two directions is greater than 300% when measured at 23° C. at a throughput speed of 50 mm/minute. This film undergoes a new tear test after spending 1 week at 40° C. in a ventilated oven. The value in the cross direction maintained 90% of its initial value; on the other hand, the value in the long direction now represents only 30% of its initial value,

### EXAMPLE 6

### According to the Invention Ratio 90%,2800, 10% 2500

Kynar flex 2800-00 (MFR=5 at 230° C. under 12.5 kg) and Kynar SuperFlex 2500-20 (MFR=7 at 230° C. under 3.8 kg) from the company Arkema are introduced into a 7-layer extruder by introducing Kynar Flex 2800 into extruders 1, 4 and 7 and Kynar Super Flex 2500-20 into extruders 2, 3, 5 and 6. This makes it possible to obtain a 5-layer film with, as layer No. 1 (extruder 1), 2800-00 30 μm thick, 2500-20 5 μm thick (extruders 2 and 3) as layer No. 2, 2800-00 30 μm thick (extruder 4) as layer No. 3, 2500-20 5 μm thick (extruders 5 and 6) as layer No. 4 and 2800-00 (extruder 7) 30 μm thick as layer No, 5. This film is extruded at a temperature of 250° C., a line speed of 7 m/minute, a draw down ratio (DDR) of 4, and a swelling ratio (BUR) of 2.65, This film is then subjected to a tear strength test in the cross direction and in the long direction according to the Elmendorf method. in the long direction the value obtained is 5 g/μm, and 25 g/μm in the cross direction. A total light transmission measurement is taken on the 100 μm film, and a value of 93% is obtained. The elongation at break value in the two directions is greater than 300% when measured at 23° C. at a throughput speed of 50 mm/minute. This film once again undergoes a tear test after spending 1 week at 40° C. in a ventilated oven, The values in the long direction and in the cross direction maintained 90% of their initial value.

### EXAMPLE 7

### According to the Invention Ratio 70% 2800, 30% 2500

Kynar Flex 2800-00 (MFR=5 at 230° C. under 12.5 kg) and Kynar SuperFlex 2500-20 (MFR=7 at 230° C. under 3.8 kg) from the company Arkema are introduced into a 7-layer extruder by introducing Kynar Flex 2800 into extruders 1, 4 and 7 and Kynar Super Flex 2500-20 into extruders 2, 3, 5 and 6. This makes it possible to obtain a 5-layer film with, as layer No. 1 (extruder 1), 2800-00 20 μm thick, 2500-20 15 μm thick (extruders 2 and 3) as layer No. 2, 2800-00 30 μm thick (extruder 4) as layer No. 3, 2500-20 15 μm thick (extruders 5 and 6) as layer No. 4 and 2800-00 (extruder 7) 20 μm thick as layer No, 5. This film is extruded at a temperature of 250° C. a line speed of 7 m/minute, a draw down ratio (DDR) of 4, and a swelling ratio (BUR) of 2.65. This film is then subjected to a tear strength test in the cross direction and in the long direction according to the Elmendorf method. In the long direction the value obtained is 8 g/μm, and 25 g/μm in the cross direction. A total light transmission measurement is taken on the 100 μm film, and a value of 93% is obtained. The elongation at break value in the two directions is greater than 300% when measured at 23° C. at a throughput speed of 50 mm/minute. This film once again undergoes a tear test after spending 1 week at 40° C. in a ventilated oven. The values in the long direction and in the cross direction maintained 90% of their initial value,

### EXAMPLE 8

### Comparative Inverted 3-Layer Structure Conserving the Ratio 80% 2800 and 20% 2500

Kynar Flex 2800-00 (MFR=5 at 230° C. under 12.5 kg) and Kynar SuperFlex 2500-20 (MFR=7 at 230° C. under 3.8 kg) from the company Arkema are introduced into a 7-layer extruder, by introducing into extruders 1, 2, 6 and 7 Kynar Flex 2500 and Kynar Super Flex 2800-00 into extruders 3, 4 and 5. This makes it possible to obtain a three-layer film with, as layer No. 1 (extruders 1 and 2), 2500-00 10 μm thick, 2800-00 80 μm thick (extruders 3, 4 and 5) as layer No. 2 and 2500-20 10 μm thick (extruders 6 and 7) for layer No. 3. This film is extruded at a temperature of 250° C., a line speed of 7 m/minute, a draw down ratio (DDR) of 4 and a swelling ratio (BUR) of 2.65. This film then undergoes a test of tear strength in the cross direction and in the long direction according to the Elmendorf method. In the long direction, the value obtained is 3 g/μm, and 7 g/μm in the cross direction. A total light transmission measurement is taken on the 100 μm film, and a value of 93% is obtained. The elongation at break value in the two directions is greater than 300% when it is measured at 23° C. at a throughput speed of 50 mm/minute. This film undergoes a new tear test after spending 1 week at 40° C. in a ventilated oven. The values in the long direction and in the cross direction maintained 90% of their initial value.

1. Multilayer fluorinated film comprising at least three layers, comprising a layer A made of a first vinylidene fluoride copolymer with a crystallization temperature TcA, and a layer B made of a second vinylidene fluoride copolymer with a crystallization temperature TcB, wherein TcA is greater than TcB, layers A and B are alternating, layer A being placed to the exterior and layer B between two layers A.

2. Multilayer film according to claim 1, in which layer A has an elastic modulus E_{A} and layer B has an elastic modulus E_{B}, wherein E_{A} is greater than E_{B}.

3. Multilayer film according to claim 1, having the structure A-B-A or A-B-A-B-A or A-B-A-B-A-B-A.

4. Multilayer film according to claim 1, in which at least one of said vinylidene fluoride copolymers are copolymers of VDF and HFP.

5. Multilayer film according to claim 1, wherein said film is free of acrylate and of olefin polymers.

6. Multilayer film according to claim 1, having a thickness of from 5 to 1000 μm, in which layer A has a thickness of from 5 to 250 μm and layer B has a thickness of from 1 to 50 μm.

7. Multilayer film according to claim 6, having a thickness of from 50 to 200 μm, in which layer A has a thickness of between 20 and 50 μm and layer B has a thickness of between 5 and 50 μm.

8. Multilayer film according to claim 1, having a tear strength measured in the direction of extrusion of greater than 5 g/μm as measured by the Elmendorf method.

9. Multilayer film according to claim 1, with haying a width of from 1 to 7 m.

10. Multilayer film according to claim 1, having a total light transmission of greater than 60% as measured by standard ASTM D 1003.

11. Multilayer film according to claim 1, having a mass content of layer B of between 5% and 50%.

12. Multilayer film according to claim 1, made in one piece with a minimum width of 5.5 m.

13. Multilayer film according to claim 1, in which layer A is a VF2/HFP copolymer with a melting point of at least 140° C., and layer B is a VF2/HFP copolymer with a melting point of less than 125° C.

14. The film according to claim 1, comprising an agricultural covering material.

15. Process for manufacturing the film according to claim 1 wherein said film is manufactured by tubular film blowing.

16. Process for manufacturing the film according to claim 1 Wherein said film is manufactured by a cast film technique.

17. Multilayer film according to claim 11, having a mass content of layer B of between 10% and 35%.

18. The multilayer film according to claim 14 comprising part of a greenhouse covering.
